(19) United States
(12) Patent Application Publication
(10) Pub. No.: US 2025/0244488 A1
(43) Pub. Date: Jul. 31, 2025

(54) INFERENCE DEVICE, INFERENCE SYSTEM, AND EQUIPMENT MAINTENANCE SYSTEM

(71) Applicant: Mitsubishi Electric Corporation, Tokyo (JP)

(72) Inventors: Moemi ASAMURA, Tokyo (JP); Tetsushi AZUMA, Tokyo (JP); Ryo KONISHI, Tokyo (JP); Makoto SASANO, Tokyo (JP)

(73) Assignee: Mitsubishi Electric Corporation, Tokyo (JP)

(21) Appl. No.: 18/805,650

(22) Filed: Aug. 15, 2024

(30) Foreign Application Priority Data
Jan. 25, 2024 (JP) 2024-009142

(51) Int. Cl. G01T 1/17; G01T 7/02

(52) U.S. Cl. CPC G01T 1/17; G01T 7/02

(57) ABSTRACT

Provided is an inference device that can swiftly and accurately infer the operation state of a radiation detection device. An inference device includes: data acquisition circuitry which acquire, as training data, a state signal outputted from a radiation detection device and indicating an operation state of the radiation detection device; and an inference circuitry which outputs the operation state of the radiation detection device on the basis of the state signal acquired by the data acquisition circuitry, using a trained model for inferring the operation state of the radiation detection device, the trained model being constructed through machine learning based on a feature quantity of the state signal.

### TECHNICAL FIELD

The present disclosure relates to an inference device, an inference system, and an equipment maintenance system.

### BACKGROUND ART

A radiation monitoring device as an equipment maintenance system is provided in a nuclear power plant site or in the peripheral site area, and is used for management of radiation from a radioactive material and early detection for abnormality occurring in the nuclear power plant. The radiation monitoring device is, in view of its importance, required to have reliable nuclear power plant monitoring performance. In addition, the number of components such as a radiation detector that the radiation monitoring device has is large, and these components output a large number of complicated signals. Therefore, it is desired that a maintenance method for the radiation monitoring device is simplified.

Conventionally, a radiation monitoring device as an equipment maintenance system that can accurately perform determination for soundness of the radiation monitoring device while the determination processing is simplified, is disclosed as shown below.

That is, the conventional radiation monitoring device has, as a basic configuration, a calculator for calculating a statistic quantity of a detector signal and a multiplexed wave-height analysis device for performing spectrum measurement. The radiation monitoring device detects an abnormal change in a measurement value, and at the same time, measures a change in a spectrum in accordance with a sequence corresponding to the type of each detector, to confirm soundness of the device. In addition, the radiation monitoring device is provided with a waveform observation device, to confirm whether or not there is abnormality in a signal. Thus, whether the abnormality is due to a measurement target (radiation) or due to characteristic change abnormality on the device side is discriminated, to detect abnormality at an early stage (see, for example, Patent Document 1).

### CITATION LIST

### Patent Document

Patent Document 1: Japanese Laid-Open Patent Publication No. 6-324158

### SUMMARY OF THE INVENTION

### Problem to be Solved by the Invention

The conventional radiation monitoring device as described above confirms soundness of the device by measuring changes in spectra in accordance with sequences corresponding to the types of a plurality of detectors. However, if the number of the detectors is large or the detectors output a large number of complicated signals, determination for soundness of the radiation monitoring device is complicated, resulting in such problems that the soundness cannot be determined accurately and it takes time to perform the determination, for example.

The present disclosure has been made to solve the above problems, and an object of the present disclosure is to provide an inference device, an inference system, and an equipment maintenance system that can infer soundness of a radiation detection device accurately and in a simplified manner.

### Means to Solve the Problem

An inference device according to the present disclosure includes: a data acquisition unit which acquires, as training data, a state signal outputted from a radiation detection device and indicating an operation state of the radiation detection device; and an inference unit which outputs the operation state of the radiation detection device on the basis of the state signal acquired by the data acquisition unit, using a trained model for inferring the operation state of the radiation detection device, the trained model being constructed through machine learning based on a feature quantity of the state signal.

An inference system according to the present disclosure includes: the inference device configured as described above; and a display unit which acquires, via a network, the operation state of the radiation detection device outputted from the inference device, and displays the operation state.

An equipment maintenance system according to the present disclosure includes: a plurality of the radiation detection devices; a data collection unit which collects the state signals outputted from the plurality of radiation detection devices; and the inference system configured as described above.

### Effect of the Invention

The inference device, the inference system, and the equipment maintenance system according to the present disclosure make it possible to provide an inference device, an inference system, and an equipment maintenance system that can infer soundness of the radiation detection device accurately and in a simplified manner.

### BRIEF DESCRIPTION OF THE DRAWINGS

FIG. 1 is a block diagram showing a schematic configuration of a monitoring device according to the first embodiment of the present disclosure;

FIG. 2 shows examples of state signals indicating the operation state of a radiation detection device according to the first embodiment;

FIG. 3 is a schematic configuration of a learning device included in an inference device according to the first embodiment;

FIG. 4 shows a neural network of the inference device according to the first embodiment;

FIG. 5 is a flowchart of a process performed by the learning device according to the first embodiment;

FIG. 6 shows a schematic configuration of an inference function unit included in the inference device according to the first embodiment;

FIG. 7 is a flowchart of a process performed by the inference function unit according to the first embodiment;

FIG. 8 illustrates estimation for an abnormality factor performed by the inference device according to the first embodiment;

FIG. 9A shows an example of a pulse height spectrum as a state signal according to the first embodiment, and FIG. 9B shows an example of the shape of a pulse height spectrum that has changed; and

FIG. 10 shows a hardware configuration of a control device for an estimation device according to the first embodiment.

### DESCRIPTION OF EMBODIMENTS

### First Embodiment

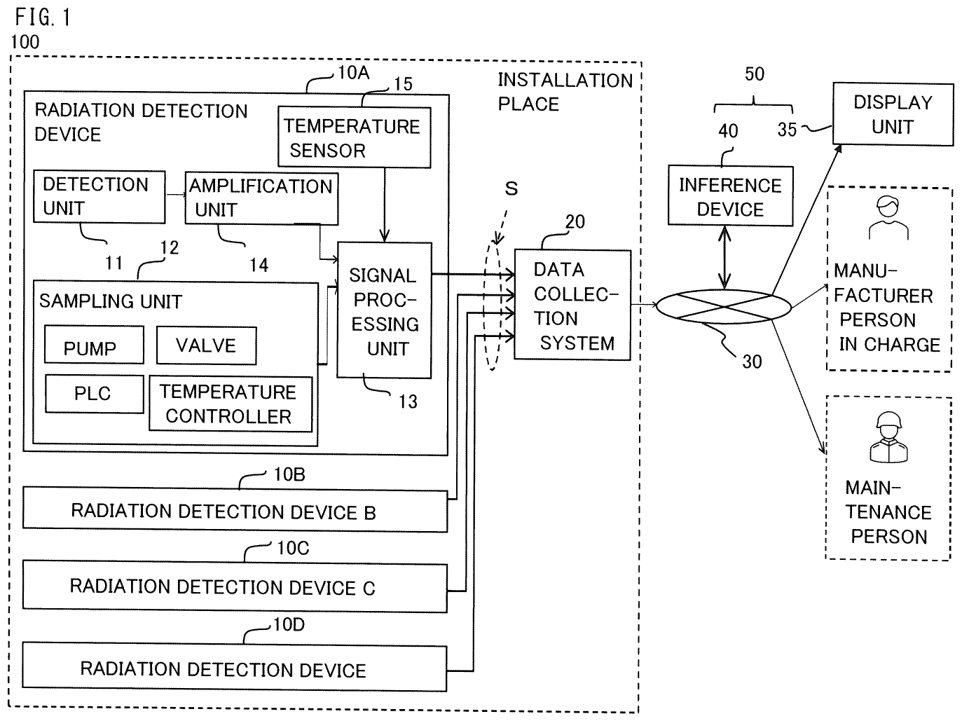

FIG. 1 is a block diagram showing a schematic configuration of a monitoring device 100 as an equipment maintenance system according to the first embodiment of the present disclosure.

The monitoring device 100 monitors operation states of radiation detection devices 10A, 10B, 10C, 10D and perform determination for soundness thereof.

The monitoring device 100 includes a plurality of radiation detection devices 10A, 10B, 10C, 10D provided in a nuclear power plant site or in the peripheral site area, a data collection system 20 which collects state signals S outputted from the radiation detection devices 10A, 10B, 10C, 10D, and an inference system 50 which infers and outputs the operation states of the radiation detection devices 10A, 10B, 10C, 10D on the basis of the state signals S.

In the following description, when the radiation detection devices 10A, 10B, 10C, 10D need not be discriminated from each other, they are simply referred to as radiation detection devices 10.

First, the configuration of each radiation detection device 10 will be described.

In the following description, it is assumed that the plurality of radiation detection devices 10A, 10B, 10C, 10D have the same configuration.

The radiation detection device 10 includes a detection unit 11, an amplification unit 14, a sampling unit 12, a signal processing unit 13, and a temperature sensor 15, as components composing the radiation detection device 10.

When having received radiation emitted from a radioactive material (not shown), the detection unit 11 outputs a detection signal having a pulse height corresponding to an energy value of the received radiation. The detection unit 11 is, for example, a scintillation detector or a semiconductor detector.

The amplification unit 14 amplifies a slight detection signal outputted from the detection unit 11, and transmits the amplified signal to the signal processing unit 13.

The sampling unit 12 is for collecting water, air, or gas as a medium containing a radioactive material, and includes a pump, a valve, a control device (PLC: programmable logic controller), and a temperature controller, for collecting the medium.

The signal processing unit 13 has a function of converting a received detection signal to a radiation level signal indicating an energy value of radiation. In addition, the signal processing unit 13 has a function of operating the sampling unit 12, a diagnosis function of diagnosing whether or not there is abnormality in the sampling unit 12, and a self-diagnosis function of diagnosing whether or not there is abnormality in hardware or software forming the signal processing unit 13.

The signal processing unit 13 outputs the radiation level signal indicating the energy value of radiation, as the state signal S indicating the operation state of the radiation detection device 10.

Hereinafter, the state signal S will be described.

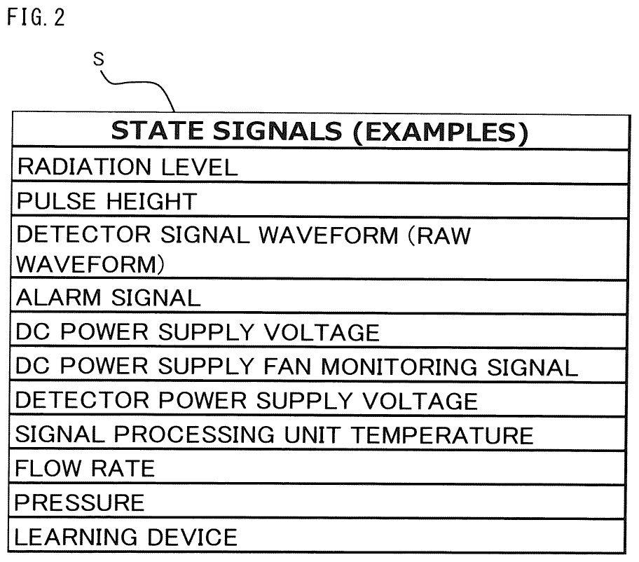

FIG. 2 shows examples of the state signals S indicating the operation state of the radiation detection device 10.

In the signal processing unit 13, as shown in FIG. 2, the state signals S indicating the operation state of the radiation detection device 10 include, besides the radiation level signal, a pulse height in an energy pulse height distribution indicating a count for each energy value of a detection signal from the detection unit 11, a detector signal waveform (raw waveform), and detection signals from an alarm, a DC power supply, a DC power supply fan, a flowmeter, a pressure meter, a thermometer, etc., as components composing the radiation detection device 10 and the signal processing unit 13.

As described above, the state signals S outputted from the radiation detection device 10 include a radiation level signal measured when the detection unit 11 for radiation reacts to radiation present in the nuclear power plant site or in the peripheral site area, detection signals from detectors, etc., as components composing the radiation detection device 10, and the like.

The data collection system 20 collects the state signals S outputted from the radiation detection devices 10A, 10B, 10C, 10D, and accumulates the state signals S in an internal data lake.

Next, operation of the inference system 50 will be described.

The inference system 50 is connected to the data collection system 20 via a network 30 which is the Internet or a dedicated line.

The inference system 50 includes an inference device 40 which performs determination for soundness of the radiation detection device 10, using the state signals S accumulated by the data collection system 20, and a display unit 35 which displays a result of determination outputted from the inference device 40.

The inference device 40 has a state monitoring function, an abnormality detection function, a determination function, an abnormality factor estimation function, and an inspection management function, for monitoring the operation state of the radiation detection device 10, using the state signals S collected by the data collection system 20.

The state monitoring function is a function of always monitoring the operation state of the radiation detection device 10.

The abnormality detection function is a function of detecting that the radiation detection device 10 exhibits a behavior different from that in a normal operation state and thus might have a failure.

The determination function is a function of determining whether abnormality is due to change in the surrounding environment where the radiation detection device is provided or due to a component composing the radiation detection device 10.

The abnormality factor estimation function is a function of, in a case where there is an abnormality factor in a component, specifying the component among a plurality of components composing the radiation detection device 10.

The inspection management function is a function of specifying an extendable period from a manufacturer-recommended inspection period and a part for which inspection is needed, on the basis of inspection cycles and inspection periods for components in the past and the state information of the radiation detection device 10 at present.

As described above, the inference device 40 of the present embodiment includes the above functions, to perform determination for soundness of the radiation detection device which is a monitoring target and infer the operation state thereof.

The operation state of the radiation detection device 10 inferred by the inference device 40 is displayed on the display unit 35 via the network 30. This enables an electric utility maintenance person and a manufacturer person in charge to monitor the radiation detection device 10 from a remote location and create a maintenance plan.

The configuration of the inference device 40 will be described.

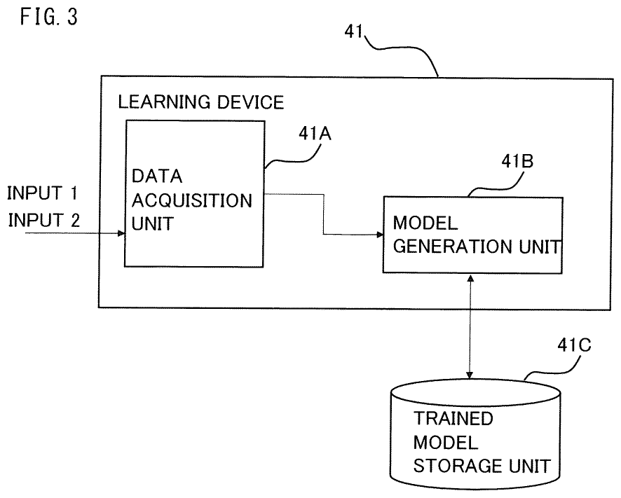

FIG. 3 is a schematic configuration of a learning device 41 included in the inference device 40 in the present embodiment.

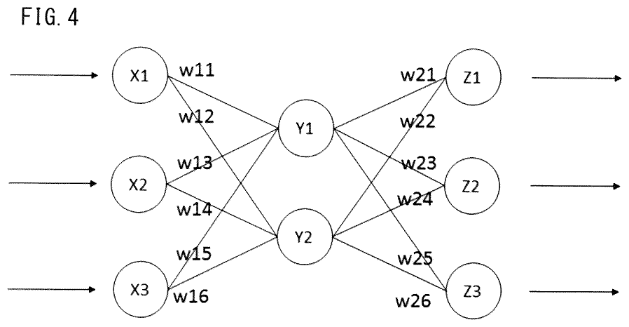

FIG. 4 shows a neural network of the inference device 40 in the present embodiment.

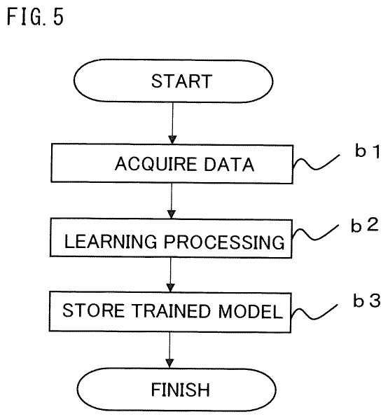

FIG. 5 is a flowchart of a process performed by the learning device 41 in the present embodiment.

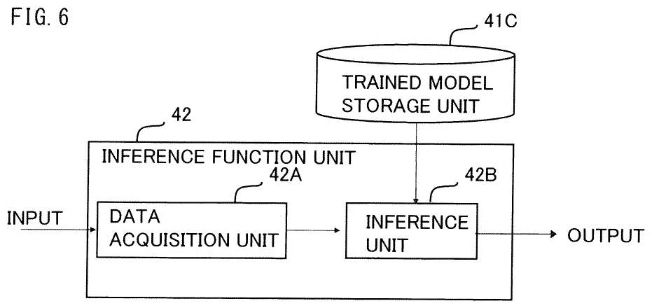

FIG. 6 shows a schematic configuration of an inference function unit 42 included in the inference device in the present embodiment.

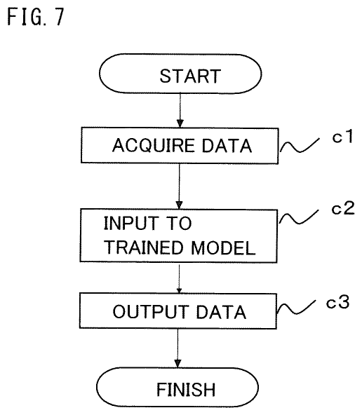

FIG. 7 is a flowchart of a process performed by the inference function unit 42 in the present embodiment.

The inference device 40 includes the learning device 41 shown in FIG. 3, the inference function unit 42 shown in FIG. 6, and a trained model storage unit 41C shown in both of FIG. 3 and FIG. 6.

The inference device 40 configured as described above infers the operation state of the radiation detection device 10 through machine learning by artificial intelligence (AI) as described below, and outputs the operate states. First, a case where the inference device 40 performs machine learning by supervised learning will be described.

Here, the supervised learning is a method in which pairs of data of inputs and results (labels) are given to a learning device to learn features included in the training data and a result is inferred from an input.

### <Learning Phase>

Hereinafter, processing performed by the learning device 41 included in the inference device 40 will be described.

As shown in FIG. 3, the learning device 41 includes a data acquisition unit 41A and a model generation unit 41B.

The data acquisition unit 41A acquires the state signal S outputted from the radiation detection device 10, as training data corresponding to an input 1.

In addition, the data acquisition unit 41A acquires the operation state (answer) of the radiation detection device 10 corresponding to a feature quantity of the state signal S, as training data corresponding to an input 2.

The training data (answer) corresponding to the input 2 is, for example, the state signal S (answer) indicating a normal state of the radiation detection device 10, the state signal S (answer) indicating an abnormal state of the radiation detection device 10, or the state signal S (answer) indicating an abnormality sign for the radiation detection device 10.

The model generation unit 41B performs learning for an output using training data created on the basis of a combination of the input 1 and the input 2 (answer) outputted from the data acquisition unit 41A. That is, the model generation unit 41B generates a trained model for inferring a correct operation state of the radiation detection device 10, from feature quantities of the input 1 indicating the state signal S of the radiation detection device 10 and the input 2 (answer).

Here, the training data is data in which the input 1 and the input 2 (answer) are associated with each other.

A case of applying a neural network as an example of a learning algorithm used by the model generation unit 41B will be described.

The model generation unit 41B performs learning for an output through so-called supervised learning in accordance with a neural network model.

The neural network is constituted of an input layer formed of a plurality of neurons, an intermediate layer (hidden layer) formed of a plurality of neurons, and an output layer formed of a plurality of neurons. The number of intermediate layers may be one, or two or more.

For example, in a case of a neural network with three layers as shown in FIG. 4, when a plurality of inputs are inputted to the input layer (X1-X3), these values are multiplied by weights W1 (w11-w16) and then are inputted to the intermediate layer (Y1-Y2). The results thereof are further multiplied by weights W2 (w21-w26) and then are outputted from the output layer (Z1-Z3). The output results vary depending on the values of the weights W1 and W2.

In the inference device 40 of the present embodiment, the neural network undergoes learning for an output through supervised learning using training data created on the basis of a combination of the input 1 and the input 2 (answer) acquired by the data acquisition unit 41A, as described above.

That is, the neural network undergoes learning by adjusting the weights W1 and W2 so that a result outputted from the output layer when the input 1 is inputted to the input layer becomes close to the input 2 (answer).

The model generation unit 41B generates a trained model by executing learning as described above, and outputs the trained model.

The trained model storage unit 41C stores the trained model outputted from the model generation unit 41B.

Next, a process for the learning device 41 to perform learning will be described with reference to FIG. 5.

In step b1, the data acquisition unit 41A acquires the input 1 and the input 2 (answer).

The present disclosure is not limited to a case of acquiring the input 1 and the input 2 (answer) at the same time, and it suffices that the input 1 and the input 2 (answer) can be inputted in association with each other. Therefore, data of the input 1 and the input 2 (answer) may be respectively acquired at different timings.

In step b2, the model generation unit 41B performs learning for an output through supervised learning using training data created on the basis of a combination of the input 1 and the input 2 (answer) acquired by the data acquisition unit 41A, to generate a trained model.

In step b3, the trained model storage unit stores the trained model generated by the model generation unit.

### <Usage Phase>

Hereinafter, processing performed by the inference function unit 42 included in the inference device 40 will be described.

As shown in FIG. 6, the inference function unit 42 includes a data acquisition unit 42A and an inference unit 42B.

The data acquisition unit 42A acquires the state signal S from the radiation detection device 10, as the input 1.

The inference unit 42B performs inference using the trained model 41C and outputs a result thereof. That is, the input 1 acquired from the data acquisition unit 42A is inputted to the trained model, whereby the operation state of the radiation detection device 10 inferred from the input 1 can be outputted.

In the present embodiment, it has been described that the operation state of the radiation detection device 10 is outputted using the trained model obtained through learning in the model generation unit 41B. However, such a trained model may be acquired from the outside of the inference device 40, and then the operation state may be outputted from the trained model.

Next, processing by the inference function unit 42 will be described with reference to FIG. 7.

In step c1, the data acquisition unit 42A acquires the input 1 which is the state signal S.

In step c2, the inference unit 42B inputs the input 1 to the trained model stored in the trained model storage unit 41C, and acquires an output indicating the operation state of the radiation detection device 10.

In step c3, the inference unit 42B outputs the output obtained by the trained model.

The model generation unit 41B may perform learning for an output, using training data created for a plurality of radiation detection devices 10.

The model generation unit 41B may acquire training data from a plurality of radiation detection devices 10 used in the same site area of the nuclear power plant, or may perform learning for an output, using, as training data, state signals S collected from a plurality of radiation detection devices 10 operating independently of each other in different site areas of the nuclear power plant.

Another radiation detection device 10 different from the above radiation detection devices 10A, 10B, 10C, 10D for collecting training data may be added as a monitoring target at any time during monitoring or may be removed from monitoring targets.

Further, a learning device that has learned for an output regarding one radiation detection device 10A may be applied to another radiation detection device 10B, 10C, 10D, to perform learning for an output again regarding the other radiation detection device 10B, 10C, 10D, thus performing update.

As the learning algorithm used in the model generation unit, deep learning in which extraction of feature quantities themselves is learned may be used, or machine learning may be executed in accordance with another known method such as genetic programming, inductive logic programming, or a support vector machine, for example.

Owing to the machine learning as described above, the inference device 40 of the present embodiment can perform determination for soundness of the radiation detection device accurately and in a simplified manner and monitor the operation state thereof with high accuracy, without cost increase, even in a case where the number of components composing the radiation detection device 10 is large or in a case where a large number of complicated signals are outputted from the components.

The inference device 40 is not limited to a configuration independent of the radiation detection device 10, such as a configuration connected to the radiation detection device 10 via the network 30 as shown in FIG. 1. The inference device 40 may be provided in the radiation detection device 10 or may be present on a cloud server.

The data acquisition unit 41A of the learning device 41 may acquire operation states of a plurality of components such as a detector composing the radiation detection device 10, as the state signals S, for each component. Then, the inference device 40 may derive a feature quantity for each component, and output an operation state for each component, using a trained model constructed through machine learning based on each feature quantity.

Thus, it is possible to specify an abnormality factor on a component basis of the radiation detection device 10.

In addition, in a case where abnormality has occurred in the radiation monitoring device, it is possible to estimate a failure cause location in the radiation detection device 10 before leading to failure. Thus, it becomes possible to take measures in advance and perform monitoring focused on the failure possibility location, and also it becomes possible to swiftly find a cause when failure has occurred.

In a case where the inference device 40 has outputted abnormality or an abnormality sign of the radiation detection device 10 as the operation state of the radiation detection device 10, the inference device 40 may select and output the component for which the abnormality or the abnormality sign has been inferred, from among the plurality of components.

Thus, an electric utility maintenance person and a manufacturer person in charge can swiftly recognize a component in which abnormality has occurred or can occur, whereby maintenance work can be made efficient.

The data acquisition unit 41A may acquire a plurality of state signals S at set time intervals. Then, using a trained model constructed through machine learning based on feature quantities derived from the plurality of acquired state signals S, the inference device 40 may output the operation state of the radiation detection device 10.

As described above, an analysis result regarding feature quantities indicated by time-series data is used as objective indices for creating a maintenance plan. Thus, the tendency of deterioration of the radiation detection device can be grasped. As a result, a sign of device abnormality can be detected before occurrence of abnormality, so that it becomes possible to perform predictive maintenance for taking measures before occurrence of abnormality.

At this time, if time-series data of feature quantities for each component such as a detector are used, it becomes possible to grasp the tendency of deterioration on a component basis. Thus, it becomes possible to perform individual inspection and replacement necessity setting for each component, whereby an efficient maintenance activity can be performed.

The inference device 40 may perform control for selecting and outputting a component for which inspection is needed, from among the plurality of components, using maintenance data in which inspection cycles for the respective components in the past are recorded. Thus, maintenance work can be made further efficient.

The inference device 40 may use a trained model constructed through supervised learning in which an abnormality factor is associated with a feature quantity for a case where the operation state of the radiation detection device 10 is an abnormal state. Thus, for example, in a case where abnormality is detected in a pressure as the state signal S shown in FIG. 2, an abnormality factor that has caused the pressure abnormality can be specified.

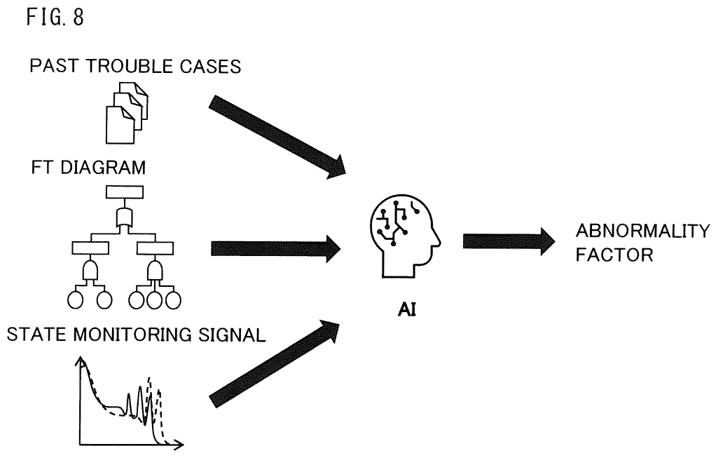

FIG. 8 illustrates estimation for an abnormality factor performed by the inference device 40.

In estimation for an abnormality factor, as shown in FIG. 8, design data of, for example, tree analysis (fault tree (FT) diagram) for analyzing causality between abnormality of the operation state of the radiation detection device and the influence of the abnormality, past trouble information, and the like may be added as input data, to improve estimation accuracy.

The inference device 40 may use the trained model constructed through supervised learning in which abnormality information is assigned to a feature quantity for a case where, as the state signal S, environment state information representing the environment in which the radiation detection device 10 is provided indicates an abnormal environment.

The level of a detection signal outputted from the detection unit 11 is slight, and therefore a radiation level signal might vary with change in the installation environment due to temperature, external noise, or the like, and thus may exhibit a behavior different from that in a normal case. By detecting abnormality of environment state information representing the environment in which the radiation detection device 10 is provided, the inference device 40 can confirm that an abnormality factor is present not in the radiation detection device 10 but in the outside environment, for example. Thus, it becomes possible to avoid unnecessary inspection for the radiation detection device 10 and the accompanying reduction in the operation rate.

In the above description, the example in which the inference device 40 performs supervised learning has been described, but the present disclosure is not limited thereto. Using a trained model constructed through unsupervised learning in which a feature quantity of the state signal S from the radiation detection device 10 in a normal state is learned, the inference device 40 may output the operation state of the radiation detection device 10.

Thus, for example, even in a case where there is no direct index for performing abnormality detection, it is possible to perform determination for the operation state of the radiation detection device 10 on the basis of a variety of determination indices such as the structure and tendency of the acquired state signals S.

In the inference system 50 of the present embodiment, both of a power maintenance person and a manufacturer person in charge who is familiar with the device structure can confirm the details of the device state of the radiation detection device 10 remotely via the network 30. Thus, it is possible to swiftly determine a coping method and take corresponding measures, whereby abnormality can be eliminated at an early stage.

Hereinafter, a case where a pulse height spectrum indicating a count for each energy value of detection signals outputted from the detection unit 11 included in the radiation detection device 10 is used as the state signal S, will be described.

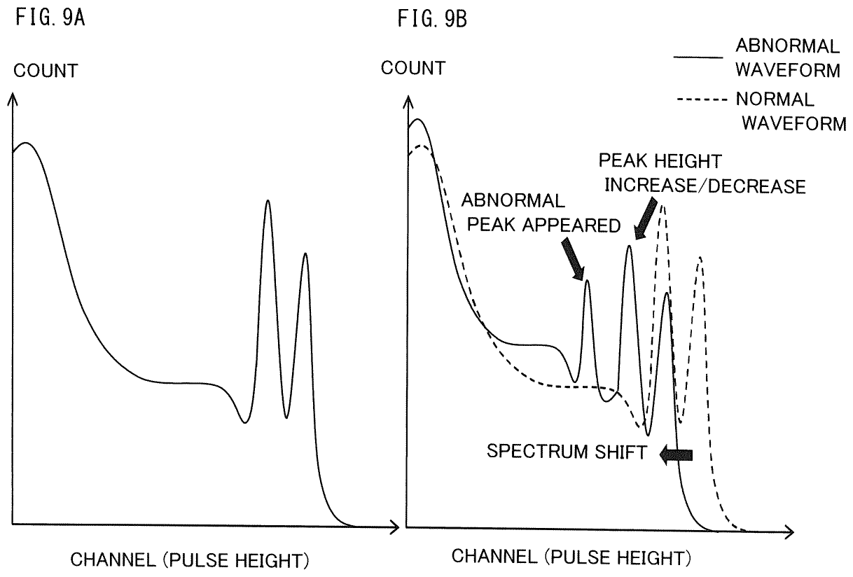

FIG. 9A shows an example of the pulse height spectrum as the state signal S.

FIG. 9B shows an example of the shape of the pulse height spectrum that has changed.

In the pulse height spectrum, as shown in FIG. 9A, peaks corresponding to detected radionuclides are detected. In a case where the outside environment has changed or abnormality has occurred in a radiation detector, the shape of the pulse height spectrum changes as shown in FIG. 9B. Therefore, a power maintenance person and a manufacturer person in charge can perform determination for soundness of the radiation monitoring device by observing a long-term change tendency of the pulse height spectrum over time.

If the inference device 40 uses data obtained by preprocessing time-series data, the data amount can be reduced. For example, as the pulse height spectrum, only peak positions may be used instead of the whole spectrum. Instead of a raw waveform of a detector signal, a pulse height value, a pulse width, or the like may be used. For a temperature, a pressure, a flow rate, or the like, a moving average or an average value over an arbitrary period may be used.

By performing such preprocessing, the data amount can be reduced and a learning period for AI can be shortened.

Hereinafter, a hardware configuration of a control device for the inference device 40 will be described.

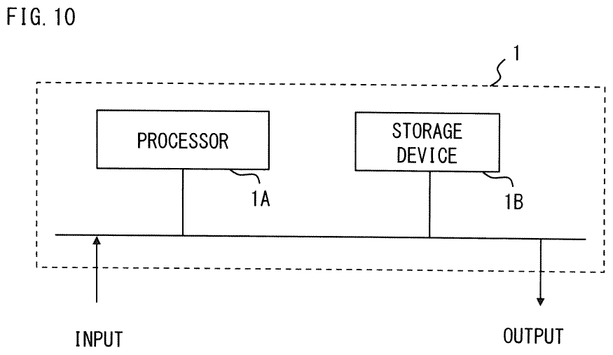

A control device 1 includes a processor 1A and a storage device 1B as shown in the hardware example in FIG. 10. The storage device 1B is provided with a volatile storage device such as a random access memory and a nonvolatile auxiliary storage device such as a flash memory, which are not shown.

Instead of the flash memory, an auxiliary storage device of a hard disk may be provided. The processor 1A executes a program inputted from the storage device 1B. In this case, a program is inputted from the auxiliary storage device to the processor 1A via the volatile storage device. The processor 1A may output data such as a calculation result to the volatile storage device of the storage device 101 or may store such data into the auxiliary storage device via the volatile storage device.

Although the disclosure is described above in terms of an exemplary embodiment, it should be understood that the various features, aspects, and functionality described in the embodiment are not limited in their applicability to the particular embodiment with which they are described, but instead can be applied alone or in various combinations to the embodiment of the disclosure.

It is therefore understood that numerous modifications which have not been exemplified can be devised without departing from the scope of the present disclosure. For example, at least one of the constituent components may be modified, added, or eliminated.

Hereinafter, modes of the present disclosure are summarized as additional notes.

### Additional Note 1

An inference device comprising:
a data acquisition unit which acquires, as training data, a state signal outputted from a radiation detection device and indicating an operation state of the radiation detection device; and
an inference unit which outputs the operation state of the radiation detection device on the basis of the state signal acquired by the data acquisition unit, using a trained model for inferring the operation state of the radiation detection device, the trained model being constructed through machine learning based on a feature quantity of the state signal.

### Additional Note 2

The inference device according to additional note 1, wherein
the data acquisition unit acquires operation states of a plurality of components composing the radiation detection device, as the state signals, for each component, and
using the trained model constructed through machine learning based on the feature quantity derived for each component composing the radiation detection device, the inference unit outputs an operation state for each component as the operation state of the radiation detection device, on the basis of each state signal acquired by the data acquisition unit.

### Additional Note 3

The inference device according to additional note 2, wherein
the data acquisition unit acquires a plurality of the state signals from the radiation detection device at set time intervals, and
using the trained model constructed through machine learning based on the feature quantities derived from the respective state signals, the inference unit outputs the operation state of the radiation detection device.

### Additional Note 4

The inference device according to additional note 3, wherein
using the trained model constructed through supervised learning in which an abnormality factor is associated with the feature quantity for a case where the operation state of the radiation detection device is an abnormal state, the inference unit outputs the abnormality factor of the radiation detection device on the basis of the state signal acquired by the data acquisition unit.

### Additional Note 5

The inference device according to additional note 4, wherein
using the trained model constructed through supervised learning in which abnormality information is assigned to the feature quantity for a case where, as the state signal, environment state information representing an environment in which the radiation detection device is provided is abnormal, the inference unit outputs whether or not abnormality has occurred in the environment in which the radiation detection device is provided.

### Additional Note 6

The inference device according to any one of additional notes 1 to 3, wherein
using the trained model constructed through unsupervised learning in which the feature quantity of the state signal from the radiation detection device in a normal state is learned, the inference unit outputs the operation state of the radiation detection device on the basis of the state signal acquired by the data acquisition unit.

### Additional Note 7

The inference device according to additional note 2, wherein
when the inference unit has inferred and outputted abnormality or an abnormality sign of the radiation detection device as the operation state of the radiation detection device,
using the trained model constructed through machine learning based on the feature quantity for each component composing the radiation detection device, the inference unit selects and outputs the component for which the abnormality or the abnormality sign has been inferred, from among the plurality of components.

### Additional Note 8

The inference device according to additional note 4 or 5, wherein
the trained model is constructed such that tree analysis for analyzing causality between abnormality of the operation state of the radiation detection device and an influence of the abnormality is incorporated.

### Additional Note 9

The inference device according to additional note 5, wherein
using the trained model constructed through machine learning based on the feature quantity for each component composing the radiation detection device, the inference unit selects and outputs the component for which inspection is needed, from among the plurality of components, on the basis of the environment state information and maintenance data in which inspection cycles for the respective components in the past are recorded.

### Additional Note 10

The inference device according to any one of additional notes 1 to 9, wherein
the inference unit outputs a normal state, an abnormal state, and an abnormal sign of the radiation detection device as the operation state of the radiation detection device.

### Additional Note 11

The inference device according to any one of additional notes 1 to 10, wherein
the state signal includes at least one of an energy distribution indicating a count for each energy value of radiation emitted from a radioactive material, a radiation intensity derived on the basis of the energy distribution, or a signal outputted as the state signal from each of a plurality of components composing the radiation detection device.

### Additional Note 12

An inference system comprising:
the inference device according to any one of additional notes 1 to 11; and
a display unit which acquires, via a network, the operation state of the radiation detection device outputted from the inference device, and displays the operation state.

### Additional Note 13

An equipment maintenance system comprising:
a plurality of the radiation detection devices;
a data collection unit which collects the state signals outputted from the plurality of radiation detection devices; and
the inference system according to additional note 12.

### DESCRIPTION OF THE REFERENCE CHARACTERS

10, 10A, 10B, 10C, 10D radiation detection device
30 network
35 display unit
40 inference device
42B inference unit
50 inference system
100 monitoring device (equipment maintenance system)

1. An inference device comprising:
a data acquisition circuitry which acquires, as training data, a state signal outputted from a radiation detection device and indicating an operation state of the radiation detection device; and
an inference circuitry which outputs the operation state of the radiation detection device on the basis of the state signal acquired by the data acquisition circuitry, using a trained model for inferring the operation state of the radiation detection device, the trained model being constructed through machine learning based on a feature quantity of the state signal.

2. The inference device according to claim 1, wherein
the data acquisition circuitry acquires operation states of a plurality of components composing the radiation detection device, as the state signals, for each component, and
using the trained model constructed through machine learning based on the feature quantity derived for each component composing the radiation detection device, the inference circuitry outputs an operation state for each component as the operation state of the radiation detection device, on the basis of each state signal acquired by the data acquisition circuitry.

3. The inference device according to claim 2, wherein
the data acquisition circuitry acquires a plurality of the state signals from the radiation detection device at set time intervals, and
using the trained model constructed through machine learning based on the feature quantities derived from the respective state signals, the inference circuitry outputs the operation state of the radiation detection device.

4. The inference device according to claim 3, wherein
using the trained model constructed through supervised learning in which an abnormality factor is associated with the feature quantity for a case where the operation state of the radiation detection device is an abnormal state, the inference circuitry outputs the abnormality factor of the radiation detection device on the basis of the state signal acquired by the data acquisition circuitry.

5. The inference device according to claim 4, wherein
using the trained model constructed through supervised learning in which abnormality information is assigned to the feature quantity for a case where, as the state signal, environment state information representing an environment in which the radiation detection device is provided indicates an abnormal environment, the inference circuitry outputs whether or not abnormality has occurred in the environment in which the radiation detection device is provided.

6. The inference device according to claim 1, wherein
using the trained model constructed through unsupervised learning in which the feature quantity of the state signal from the radiation detection device in a normal state is learned, the inference circuitry outputs the operation state of the radiation detection device on the basis of the state signal acquired by the data acquisition circuitry.

7. The inference device according to claim 2, wherein
when the inference circuitry has inferred and outputted abnormality or an abnormality sign of the radiation detection device as the operation state of the radiation detection device,
using the trained model constructed through machine learning based on the feature quantity for each component composing the radiation detection device, the inference circuitry selects and outputs the component for which the abnormality or the abnormality sign has been inferred, from among the plurality of components.

8. The inference device according to claim 4, wherein
the trained model is constructed such that tree analysis for analyzing causality between abnormality of the operation state of the radiation detection device and an influence of the abnormality is incorporated.

9. The inference device according to claim 5, wherein
using the trained model constructed through machine learning based on the feature quantity for each component composing the radiation detection device, the inference circuitry selects and outputs the component for which inspection is needed, from among the plurality of components, on the basis of the environment state information and maintenance data in which inspection cycles for the respective components in the past are recorded.

10. The inference device according to claim 1, wherein
the inference circuitry outputs a normal state, an abnormal state, and an abnormal sign of the radiation detection device as the operation state of the radiation detection device.

11. The inference device according to claim 1, wherein
the state signal includes at least one of an energy distribution indicating a count for each energy value of radiation emitted from a radioactive material, a radiation intensity derived on the basis of the energy distribution, or a signal outputted as the state signal from each of a plurality of components composing the radiation detection device.

12. An inference system comprising:
the inference device according to claim 1; and
a display circuitry which acquires, via a network, the operation state of the radiation detection device outputted from the inference device, and displays the operation state.

13. An equipment maintenance system comprising:
a plurality of the radiation detection devices;
a data collection circuitry which collects the state signals outputted from the plurality of radiation detection devices; and
the inference system according to claim 12.

14. An inference system comprising:
the inference device according to claim 2; and
a display circuitry which acquires, via a network, the operation state of the radiation detection device outputted from the inference device, and displays the operation state.

15. An inference system comprising:
the inference device according to claim 3; and
a display circuitry which acquires, via a network, the operation state of the radiation detection device outputted from the inference device, and displays the operation state.

16. An inference system comprising:
the inference device according to claim 4; and
a display circuitry which acquires, via a network, the operation state of the radiation detection device outputted from the inference device, and displays the operation state.

17. An inference system comprising:
the inference device according to claim 5; and
a display circuitry which acquires, via a network, the operation state of the radiation detection device outputted from the inference device, and displays the operation state.

18. An inference system comprising:
the inference device according to claim 6; and
a display circuitry which acquires, via a network, the operation state of the radiation detection device outputted from the inference device, and displays the operation state.

19. An inference system comprising:
the inference device according to claim 7; and
a display circuitry which acquires, via a network, the operation state of the radiation detection device outputted from the inference device, and displays the operation state.

20. An inference system comprising:
the inference device according to claim 8; and
a display circuitry which acquires, via a network, the operation state of the radiation detection device outputted from the inference device, and displays the operation state.
